(19) United States
(12) Patent Application Publication
(10) Pub. No.: US 2017/0337553 A1
(43) Pub. Date: Nov. 23, 2017

(54) METHOD AND APPARTUS FOR TRANSMITTING PAYMENT DATA USING A PUBLIC DATA NETWORK

(71) Applicant: Rubean AG, Munich (DE)

(72) Inventor: Hermann Geupel, Munich (DE)

(73) Assignee: Rubean AG, Munich (DE)

(21) Appl. No.: 15/598,500

(22) Filed: May 18, 2017

(30) Foreign Application Priority Data
May 19, 2016 (DE) 102016109209.6
Dec. 15, 2016 (EP) 16204208.9

(51) Int. Cl. G06Q 20/40; G06Q 20/32; G06Q 20/34

(52) U.S. Cl. CPC G06Q 20/405; G06Q 20/341; G06Q 20/4012; G06Q 20/3226; G06Q 20/3278; G06Q 20/3229; G06Q 2220/10

(57) ABSTRACT

A method for transmitting transaction data using a public data network, comprising the steps of:
transmitting primary transaction data from a provider data base via the public data network to a display device connected to the data network and, locally, visually and/or acoustically displaying the primary transaction data thereon, in particular visually on a displayed provider website as bar code or QR code,
b1) recording the display and generating a primary transaction file in a user terminal of an access network, or
b2) recording the display and generating a primary transaction file in a recording device and then transmitting the primary transaction file to a user terminal of an access network, via a wireless near field data transmitter of the recording device and user terminal,
processing the primary transaction file on the user terminal for extracting at least a part of the transaction data, and generating an extract file,
inputting an authorization data set of a debit or credit card configured as a smart card and equipped with a wireless near field data transmitter at the user terminal and associating the authorization data set with the extract file,
e1) transmitting the extract file and the associated authorization data set from the user terminal to the smart card wirelessly connected thereto, or
e2) internally transferring the extract file and the associated authorization data set to the smart card component in the user terminal,
f) checking the extract file in conjunction with the authorization data set by a processor of the smart card or smart card component based on comparison data stored thereon and, if correct, outputting a correctness confirmation message to the user terminal or internally in the user terminal,
g) generating a secondary transaction file comprising the primary transaction data and user data in the user terminal based on the confirmation message,
h) transmitting the secondary transaction file from the user terminal via the access network to an access server in the data network, fetching or receiving a transaction confirmation message from the access server by or at a provider receiver, at least one of visually or acoustically displaying the message on the provider website.

### INCORPORATION BY REFERENCE

The following documents are incorporated herein by reference as if fully set forth: German Patent Application No. 102016109209.6, filed May 19, 2016; and European Application No. 16204208.9, filed Dec. 15, 2016.

### BACKGROUND

The invention relates to a method and arrangement for transmitting transaction data using a public data network. Essentially, it relates to a method and system for authorizing online payments.

Nowadays, often several methods of authentication in the process of authorizing an online payment are available in online shops:
using prepayment, instant bank transfer or PIN and TAN based online banking methods, in which the customer has to have the online banking PIN at the ready and has to handle the TAN
using ApplePay and Selfie-Pay (http://www.welt.de/finanzen/verbraucher/article152595657/Mastercard-Kunden-koennen-bald-per-Selfie-bezahlen.html, biometric methods, which can result in false rejections)
using PayPal, technically a method which is not as secure, in which only a password is checked.

### SUMMARY

The object of the present invention is to provide a method and system for authorizing online payments which is simpler and more secure for the user.

In its method aspect, this object is achieved by a method as well as an arrangement with one or more of the features of the invention. Advantageous further developments of the inventive idea are described in detail below and in the claims.

Thus, the present invention provides a secure and user-friendly method and system for authorizing a transaction using smartcard and smartphone.

The invention achieves the object by means of a technical further development of the method of paying in businesses, which is in principle known to the user. By using a bank card and inputting the appropriate PIN, the user identifies him- or herself at a payment terminal and confirms the purchase price sum to be paid. With respect to the purchase of a product in an internet shop, the function of the payment terminal according to the invention is covered by the user's smartphone.

The method and system according to the invention by means of the connection of NFC-enabled debit and credit cards to a customer's NFC-enabled terminal (smartphone) achieves the following advantages:
It implements a simple payment procedure: To pay in the web shop, the customer only needs to hold his/her NFC-capable bank card close to the smartphone and input the card PIN, which he/she has to remember anyway for other business transactions like payment in businesses or for withdrawing money. The process is very familiar to the customer and therefore very simple for him/her.
It is secure and cost-effective: due to the protected mobile app installation process and the protected payment amount indication and PIN input, the customer is offered a new type of point-of-sale terminal for online and mobile purchases in the form of his/her own smartphone. In this case of a PIN-verified girocard or credit card payment, according to traditional law, the customer is liable for a theft of identity, if necessary, which ultimately results in lower fees for the dealer.

In one embodiment of the invention further steps in the data network are provided:

forwarding the secondary transaction file from the access server to a transaction server or a server system on the data network,

generating a transaction confirmation message after processing the secondary transaction file to execute the transaction on the transaction server or server system, and

fetching the transaction confirmation message by provider software, or actively sending the transaction confirmation message from the transaction server or server system to the provider receiving means.

While the authorization confirmation message provided according to the invention initially confirms that the intended transaction is authorized by the user and his/her bank, the actual transaction may take place at a later time and is also only then confirmed as an actually executed transaction according to the above-mentioned steps. If, for any reason, the transaction is not executed, these steps are, of course, omitted, or they are replaced by messages that communicate the non-execution of the transaction (and optionally the reasons).

In a further embodiment, the method comprises a further step of transmitting the authorization confirmation message via the access server and the access network to the user terminal of the access network and displaying it thereon. Optionally, the valid authorization is displayed to the user (additionally or alternatively to the display via the website of the provider) on his/her smartphone or tablet.

In a further embodiment of the invention, the public data network is an IP network and the display device is a display device of a computer 0, the display content of which is loaded from a web page 1 in which, in particular, a plug-in software module for carrying out steps a) and l) is installed. In particular, provision is made here for the transaction data in step a) to be displayed visually as a bar code or QR code.

Furthermore, the access network is, in particular, a mobile communications network or WLAN and the user terminal is a smartphone or tablet on which a mobile app is installed for executing, in particular, steps c)-e2) and g). Recording the display presented by the display device comprises, depending on the type of display, in particular scanning an optical display using a built-in camera of the user terminal or also using a separate camera; but, in principle, it can also comprise a sound recording of a spoken character string or another acoustic display.

An embodiment in which the user terminal and the smart card communicate bi-directionally via near-field communication, NFC, protocol and the EMV standard for chip-based payment cards is advantageous for the essential data exchange between the user terminal and the smart card.

Furthermore, in practice it is envisaged that in step c the authorization data set includes a PIN of the credit card or girocard (bank card). Alternatively, a data set of physiological user data (fingerprint, retinal image, voice profile, etc.) may also be used in principle, but this results in a higher risk of rejection for the intended transaction.

The portion of the transaction data, in the claims referred to as extract file, which is transmitted to the smart card (bank card) along with the PIN, may be the transaction amount. If the credit limit recorded on the smart card is larger than the transaction amount, the smart card deposits the difference as a new credit limit. Communication with the server system is not necessary in this case. However, the confirmation server is notified of the approved transaction by means of the transaction data set.

According to the above-mentioned EMV standard, the transmission of the extract file and the PIN to the bank card in step e) and the output of the correctness confirmation message in step f) are split into a plurality of individual steps in which first the PIN on the card is checked and then, on the basis of the extract file, a digital signature is generated by means of an asymmetrical encryption method or a cryptogram is generated by means of a symmetrical encryption method and is returned as a confirmation message to the smartphone. In step g), the smartphone then generates a secondary transaction file that includes the confirmation message and is passed to the bank server system for execution of the transaction.

In another embodiment preferred from the current point of view, provision is made for the user terminal communicating to the access server and server system by means of the nexo protocol (http://www.nexo-standards.org/sites/default/files/nexo%20whitepaper%20-%20final%20edited%20version.pdf).

While, from the current point of view, the most important configuration within the scope of the invention includes a smart card which is separate from the user terminal, the invention also includes the option that the user terminal incorporates a smart card component or functionality internally. In particular, in step e2) provision is made for the mobile app checking the authorization data set in comparison with a secure element on a SIM card or comparable components of the user terminal.

In a further embodiment of the method, a proprietary input field is generated on the touch screen of the user terminal for outputting the PIN of the credit card or girocard, wherein, in particular, the position of the input field on the touch screen is specified specifically for each input operation or for individual numeral inputs of an input operation.

Furthermore, in the interest of high security, an embodiment is preferred in which the steps executed in the user terminal are executed within a trusted execution environment, TEE, by a processor of the user terminal in a secure mode, wherein a switch to secure mode is effected by the mobile app. In particular, provision is made here for the mobile app authenticating itself to the processor of the user terminal as a secure mobile app by means of a public key method.

In a further embodiment, the method is configured such that steps k) and m) are executed at least partially via a confirmation function of the access server, irrespective of the current operating state of the user terminal.

In a further embodiment of the method, the authenticity of the mobile app is demonstrated to the user by the fact that the plug-in software module displays a warning message to the user that the transaction data has been acquired by an authentic mobile app if the plug-in software module has not received a confirmation message from the confirmation server in a certain time after the presentation of the transaction data on the web page.

It is only through the information circulation described above that the user can be sure that the mobile app on his/her user terminal does not only superficially appear as an authentic mobile app but also acts as one. Technically, the mobile app can prove its authenticity to the confirmation server, for example, by signing data with its private key, which is the counterpart to a public key known to the confirmation server.

For reasons of user friendliness, such a proof of the authenticity of the mobile app via the described information circulation may also be carried out only once during the installation of the mobile app and not every time during an online purchase. In this case, the user starts the download of the mobile app according to the invention preferably from a trustworthy web page, in which the web page (for example, Google Play Store), from which the mobile app is downloaded, is embedded as iframe.

At the end of the app installation process, the mobile app switches to a QR scanning mode and the user is prompted to scan the QR code displayed on the trustworthy web page. The QR code transmits a web session ID to the mobile app, which allows the mobile app to establish a web session with the trustworthy web page and then to authenticate itself using a digital signature. The authentication result displayed on the trustworthy web page, also called “remote attestation”, allows the user to check the authenticity of the downloaded mobile app.

In order to be able to demonstrate the authenticity of the downloaded mobile app to the user over the further life cycle thereof, after installation of the mobile app the user is prompted, for example, to draw an arbitrary figure with the finger or to write something on the touch screen of the smartphone. This signature will be displayed as a background image by the mobile app whenever the mobile app is operating in Trusted Execution Environment (TEE) mode, for example, when displaying the payment amount for ordering or requesting the card PIN.

The communication between the mobile app and the confirmation server may also be encrypted.

The transaction data may be transferred from the web page to the mobile app in a tamper-proof manner, wherein the plug-in software module essentially only displays one transaction number on the web page and the mobile app provides the actual transaction data assigned to the transaction number via the confirmation server. Device or system aspects of the present invention arise to a large extent from the method aspects described above and are not repeated here. It is to be noted that configurations are also included here in which a smart card separate from the user terminal or a smartcard component included in the user terminal is used.

### BRIEF DESCRIPTION OF THE DRAWINGS

Advantages and usefulness of the invention will be apparent from the following description of an exemplary embodiment and embodiments of the invention with reference to the figures. In the figures:

FIG. 1 is a schematic diagram of an arrangement according to the invention,

FIG. 2 shows another schematic diagram of the arrangement according to the invention,

FIG. 3 shows a partial aspect of an embodiment of the arrangement shown in FIGS. 1 and 2,

FIGS. 4A to 4E show a further partial aspect of an embodiment of the arrangement shown in FIGS. 1 and 2;

FIG. 5 is a schematic diagram of a further arrangement according to the invention, and

FIG. 6 shows a further partial aspect of an embodiment of the arrangement shown in FIGS. 1 and 2.

### DETAILED DESCRIPTION OF THE PREFERRED EMBODIMENTS

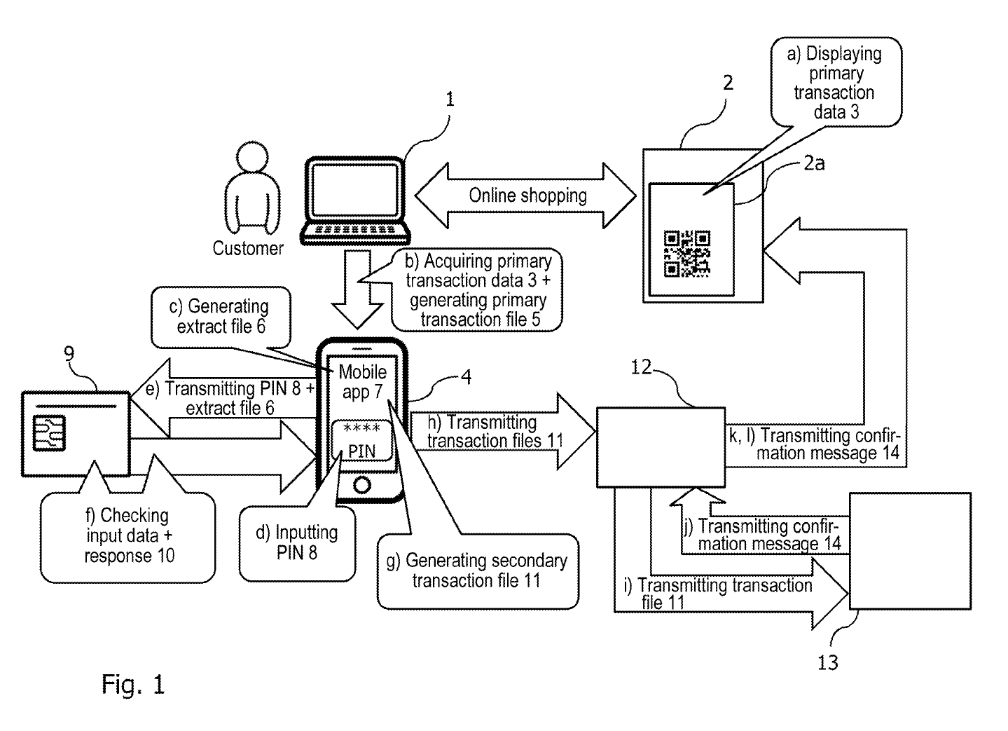

The invention achieves the object by providing a method for authorizing and executing a transaction which, according to FIG. 1, includes the following steps in an advantageous embodiment and in simplified wording:
a) presenting (primary) transaction data 3 on a web page 2, controlled by a plug-in software module 2a, on the display screen of a computer 1 used by a customer in an online purchase;
b) automatically acquiring the transaction data 3 for generating a primary transaction file 5 by a smartphone 4 of the user and displaying the primary transaction file 5 thereon;
c) processing the primary transaction file 5 on the smartphone 4 for extracting at least a part of the transaction data and generating an extract file 6 by means of a mobile app 7 installed on the smartphone 4,
d) inputting a PIN 8 of a debit or credit card configured as a smart card 9 and equipped with means for wireless near field data transmission on the smartphone 4 and associating the PIN with the extract file 6,
e) transmitting the extract file 6 and the associated PIN 8 from the smartphone 4 to the smart card 9 wirelessly connected thereto,
f) checking the extract file 6 in conjunction with the PIN 8 by a processor of the smart card 9 based on comparison data stored thereon and, if correct, outputting a correctness confirmation message 10 to the smartphone 4,
g) generating a secondary transaction file 11 comprising the primary transaction data and user data on the smartphone 4 based on the confirmation message 10
h) transmitting the secondary transaction file 11 from the smartphone 4 via the access network to an access/confirmation server 12 in the data network,
i) forwarding the secondary transaction file 11 from the access/confirmation server 12 to a server system 13 in the data network,
j) generating a transaction confirmation message 14 after processing the secondary transaction file 11 for execution of the transaction in the server system 13,
k) fetching the transaction confirmation message 14 by provider software;
l) receiving the transaction confirmation message 14 from the access/confirmation server 12 at a provider receiving means (not shown) and visually and/or acoustically displaying the message on the provider website 2.

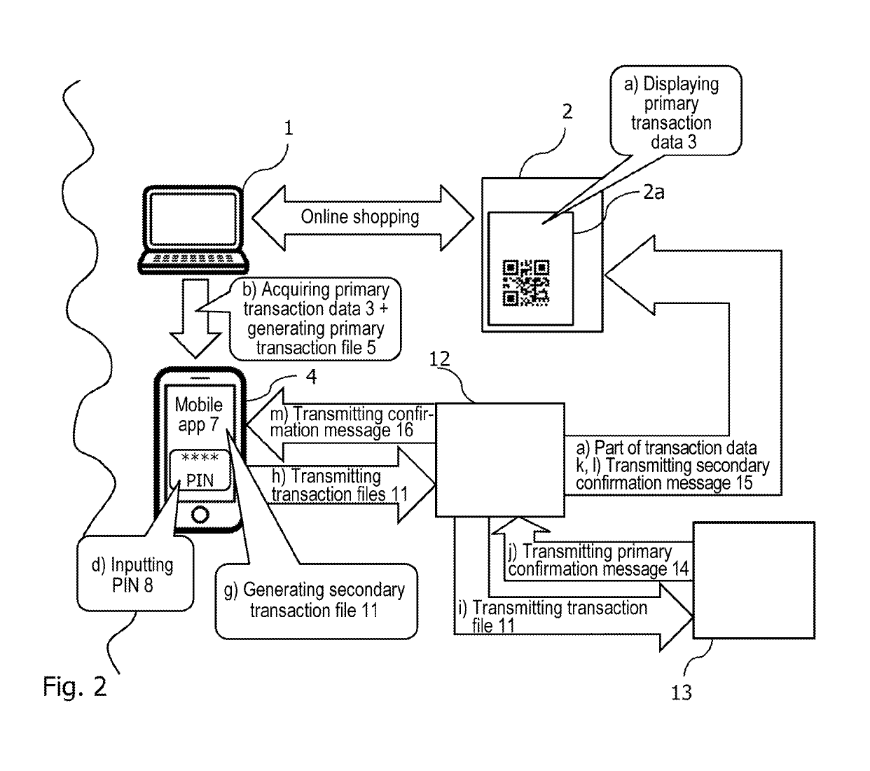

FIG. 2 shows the communication steps relating to the authorization of the transaction and confirmation of its execution in more detail. Herein, provision is made for the smartphone 4 and the server system 13 to communicate at least a part of the data in the transaction file 11 and the (primary) confirmation message 14 encrypted and digitally signed and for the access/confirmation server 12 to nevertheless be able to read from this communication whether the server system 13 confirms the execution of the transaction and to send this information as a secondary confirmation message 15 to the plug-in software module 2a.

In particular, this is arranged in such a way that the plug-in software module 2a supplies the access/confirmation server 12 with a part of the transaction data at the time of the display of the transaction data 3 on the web page 2 and the access/confirmation server 12 can later associate the secondary confirmation message 15 with this initially received part of the transaction data 3.

The process according to FIG. 2 also differs from the process shown in FIG. 1 in that, upon receipt of the primary confirmation message 14′, the access/confirmation server 12 generates a confirmation message 16 for receiving and displaying on the smartphone 4 and sends it directly thereto via the access network (step m).

If the method according to the invention is embedded in a mobile commerce process, the use of a computer 1 and step a) according to the invention, in which the primary transaction data 3 is displayed on the web page 2 graphically, for example, as QR code, are omitted. In this case, step b) changes in such a way that the primary transaction data 3 no longer has to be scanned by the smartphone 4, but instead is transferred as part of a data communication from the web page 2 to a browser located on the smartphone.

If the online retailer does not want to make the payment method according to the invention obviously selectable for all buyers because only a portion of the buyers are equipped with smartphones 4 and smart cards 9 according to the invention, the mobile commerce variant of the payment method according to the invention may also be integrated into an already established payment system.

In this case, the initial web page of the established payment system may include a JavaScript that is loaded into the smartphone browser and there acquires the user agent string, and, if it indicates an Android based Chrome browser, directs the browser to a new web page on which the user has to confirm the further progress by pressing a menu button. Subsequently, the new web page returns an URL to the Chrome browser, which is configured such that the browser is either caused by means of an Android Intent Call to open a mobile app 7 according to the invention installed on the smartphone, or, if this is not possible, is redirected to the initial page of the established payment system.

The established payment method is also applied when the JavaScript of the initial web page judges, based on the determined user agent string, that the connected browser is not an Android-based Chrome browser.

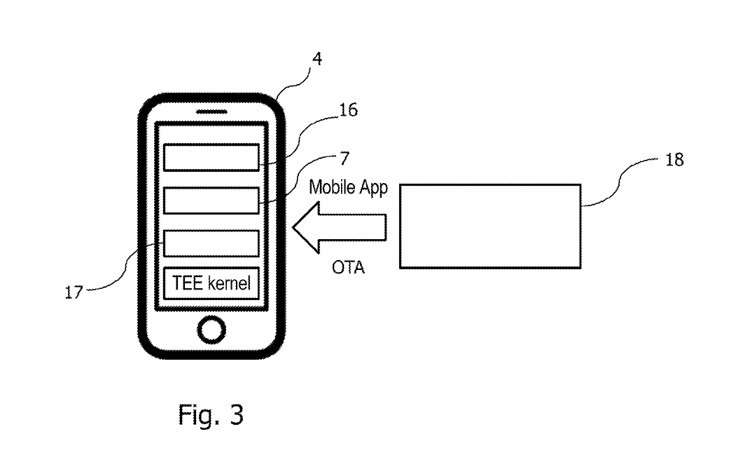

FIG. 3 schematically illustrates that the mobile app 7 runs in a trusted execution environment 16 on the smartphone and securely drives certain hardware resources 17 such as the keyboard, the display and the NFC controller of the smartphone. The smartphone 4, as part of the hardware resources 17, contains a device key with which the smartphone authenticates itself. The device key is a private key in terms of the Public Key Infrastructure (PKI).

Before executing the method, the mobile app is loaded by an app loading system 18 in the over-the-air method OTA into the trusted execution environment 16 of the smartphone 4 after the smartphone has authenticated itself to the app loading system 18 by means of its device key.

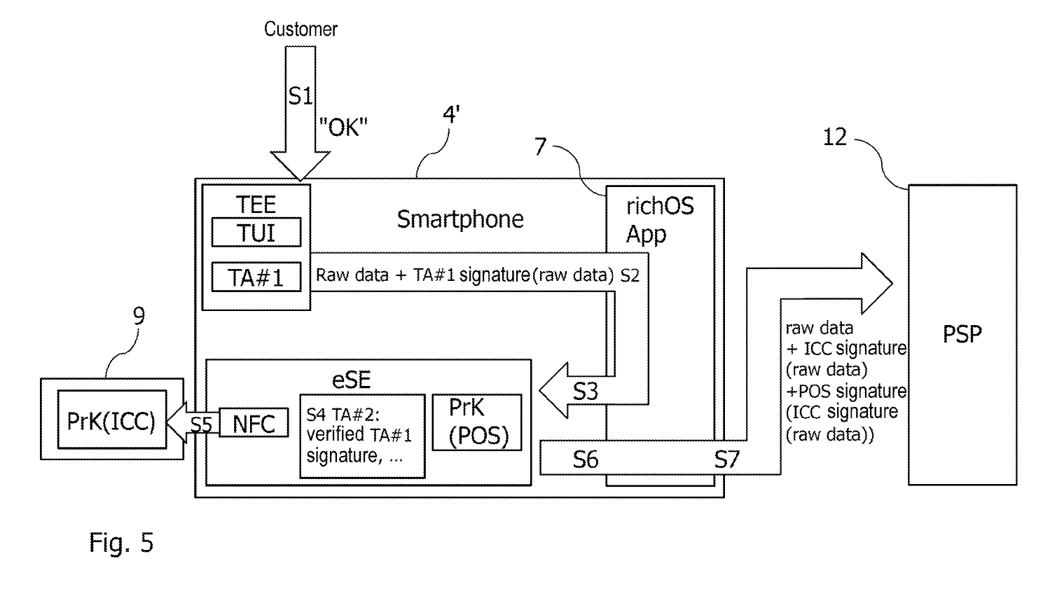

FIG. 5 shows an implementation of the mobile app on Samsung S6 and S7 smartphones, wherein the reference numerals for the components from FIGS. 1-3 are used and the essential steps of the process are designated by S1 . . . S7. The mobile app 7 is divided into three parts, a richOS Android part, a Trusted App#1 part (TA#1) running in the Trusted Execution Environment, and a Trusted App #2 part (TA#2) running in the embedded Secure Element (eSE).

The main task of the TA#1 is to provide a secure user interface, via which the correct payment data are displayed and the card PIN is entered securely.

The main task of the TA#2 is the secure communication with the peripheral components, the smart card 9, and the confirmation server (PSP) 12 and the server system 13 with cryptographic keys, which are loaded onto the eSE as part of the mobile app installation process and thenceforth operate securely therefrom.

The communication between both Trusted Apps occurs via the insecure part of the mobile app, i.e., the richOS Android part of the app. To ensure that the card PIN cannot be tapped when it is transmitted from TA#1 to TA#2, TA#1 encrypts it with the public key of TA#2. To ensure, that the payment data displayed to the user and confirmed by the user cannot be tampered with thereafter, they are digitally signed in TA#1 and verified for integrity in TA#2 prior to the communication to the smart card.

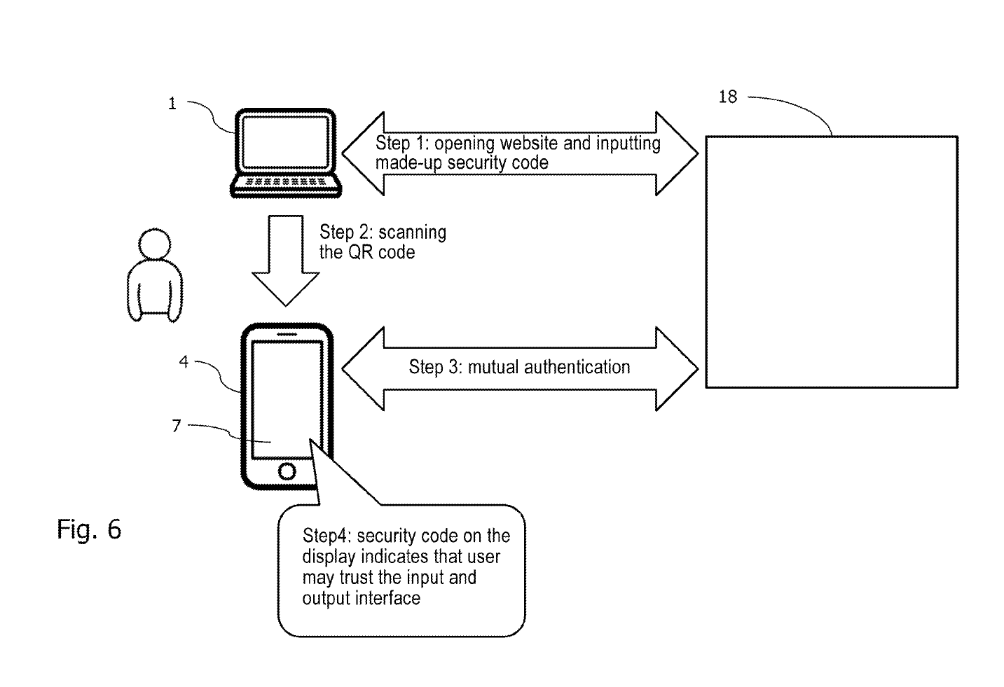

A possible fraud scenario is that the user in the app store is offered a fake mobile app for download which, since the appropriate cryptographic key is lacking, does not make payments, but can obtain the card PIN by espionage. FIG. 6 shows a method for defending against such card PIN phishing, which allows the user to verify at the end of the app installation and from then on each time the application is used, whether the trusted screen interface, the so-called trusted user interface, is genuine.

After the mobile app 7 with its two trusted apps has been installed on the user's smartphone 4, the user, in the first step, opens a website via a second device, for example the user's laptop, to check the authenticity of the mobile app 7, which is therefore called “Remote Attestation Web Page”. On the website, the user enters a security code, which the user has made up himself/herself.

In the second step, the user scans a QR code, which is displayed on the website, with the user's mobile app. The QR code indicates the web session to the mobile app, in which the laptop and a web server 18 belonging to the website are currently connected and allows the mobile app 7 to log into the same web session.

In the third step, the mobile app 7 and the website authenticate each other. For the mobile app 7, preferably a private key of TA#2 is used.

In the fourth step, after a successful authentication, the web server 18 confidentially shares with the mobile app 7 the security code previously entered by the user, preferably encrypted with the public key of TA#2 used in the mutual authentication. The TA#2 passes the security code confidentially to the TA#1, which then displays it as a sign of authenticity on the trusted user interface.

In a slightly modified process, the security code could also be entered via the trusted user interface (TUI) and then be displayed on the “Remote Attestation Web Page” to check the authenticity of the TUI.

To enhance security, the mobile app 7 is preferably restricted to the communication with selected smart cards 9 assigned to the user. In this case, the mobile app could not communicate with any other smartcards and initiate payments via them.

The user registers the smart card 9 on the mobile app 7 as one assigned to the user. For this, before the first use of the smart card, the bank account associated with the smartcard must be entered into the mobile app, and then the reason for payment of an automatic transfer to this account must be read and finally must be entered into the mobile app for authentication.

As an alternative to this process, which is quite complex for the user, the mobile app may be restricted to the use of a certain number of smartcards over its entire life cycle. For this, the confirmation server 12, via which the transaction files 11 are passed, monitors the combinations of the IDs of the mobile app 7 and the cards 9 and stops a transaction file 11 when it was signed by a card 9 that exceeds the allowable maximum amount of cards assignable to one mobile app 7.

In the proposed method, the smartphone, which plays a central role having the function of a point-of-sale terminal in the communication chain between user, card and bank of the retailer, has to meet special security requirements. The solution according to the invention must, for example, prevent the card PIN from being tapped by malicious software on the smartphone and prevent the smartphone from authorizing a different amount and recipient for the payment from that displayed to and authorized by the user.

The invention meets the security requirements on the smartphone in particular by using a so-called Trusted Execution Environment (TEE). As part of a TEE, the smartphone may have a processor the arithmetic register of which can operate in normal and secure mode. In the secure mode according to the invention, operating system functions such as securely displaying the amount and the recipient and entering the PIN, which are not available in normal mode, can be executed. The register is switched to secure mode by the mobile app according to the invention after the mobile app has authenticated itself to the register as a secure mobile app by means of a public key method.

Said entry of the girocard PIN via the smartphone poses a particular security risk because the girocard PIN fulfils a central function, such as for withdrawing cash and paying in businesses, and corrupted PINs could cause enormous damage. On the other hand, smartphones present a larger target to potential attackers than point-of-sale terminals more restricted in function. Therefore, special security measures are required to protect a PIN entered via the smartphone from spying.

Malicious software (malware) on the smartphone could intercept the communication between the operating system of the smartphone and the mobile app when the PIN is entered via the given keyboard of the smartphone.

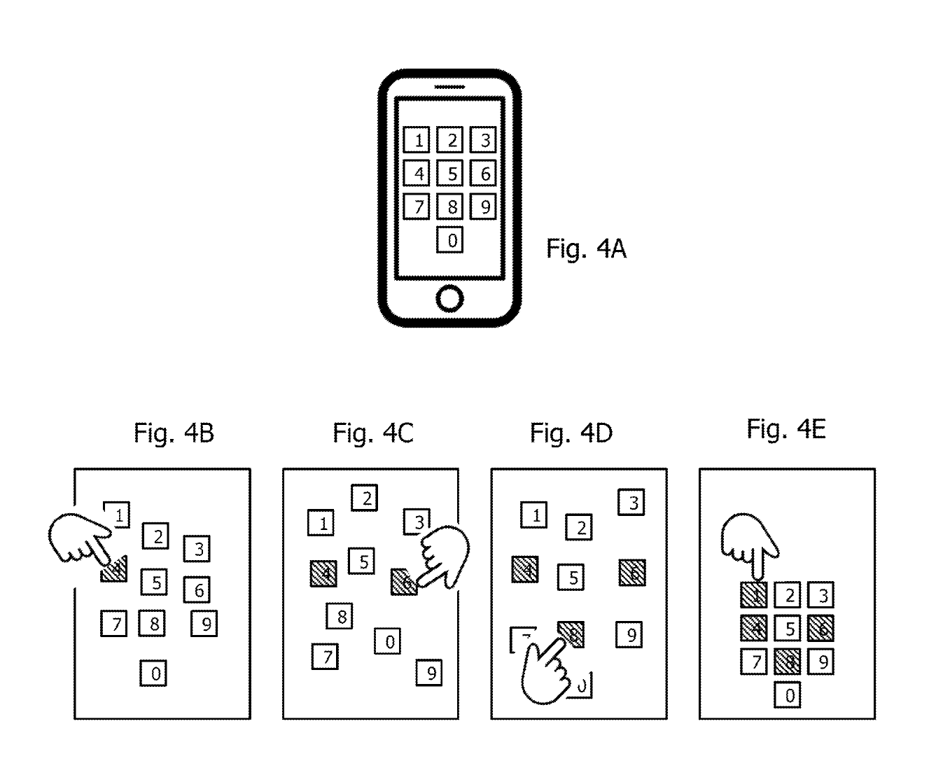

A specially configured mobile app provides the customer with a separate PIN input keypad on the touch display that is different from the standard keypad of the smartphone operating system, as discussed below with reference to FIGS. 4A to 4E.

If the keypad would be displayed statically, the malicious software might recognize a pattern that indicates the PIN due to the 4 touch points on the display. The keypad is therefore advantageously displayed differently on the touch display
a) for each customer,
b) for each PIN entry, or even
c) for each individual PIN number.

A different display of the keypad may mean that
1. the entire keypad or individual number fields are displayed differently in size,
2. the entire keypad or individual number fields are slightly rotated
3. the entire keypad or individual number fields are moved to the left/right and upwards/downwards.

Further embodiment: When the PIN input keypad moves to another location on the display before the entry of each PIN number, this could create memory problems for the customers, which memorize the PIN by means of a graphical input pattern on the display. In order to show the customer which keys have already been pressed, the keys on the keypad already pressed could be specially marked. In addition, it could be shown graphically how many of the 4 numbers have already been entered.

Further embodiment: In order to make it more difficult for malicious software to analyze the embedded display image and thus the position of the keypad, also the mechanisms of web pages, which defend against automated denial-of-service attacks by displaying numerical codes to be entered manually in a pictorial manner, could be used. In reference to the display of the keypad field according to the invention, this means that lines and numbers are not displayed via XML functions but as images.

Further embodiment: While the keyboard field in the embodiments above is distorted but keeps its number arrangement structure, in a further embodiment the number layout on the keypad field may also be shuffled arbitrarily. For customers memorizing the PIN by means of a graphical input pattern on the display, a different number layout would mean a disadvantage, however.

The embodiment of the invention is not limited to these examples, but a variety of modifications which are within the scope of skill in the art are possible.

1. A method for transmitting transaction data using a public data network, comprising the steps of:
transmitting primary transaction data from a provider data base via said public data network to a display device connected to the data network and, locally, at least one of visually or acoustically displaying said primary transaction data thereon, in particular visually on a displayed provider website as bar code or QR code,
b1) recording the display and generating a primary transaction file in a user terminal of an access network, or
b2) recording the display and generating a primary transaction file in a recording device and then transmitting said primary transaction file to a user terminal of an access network, via a wireless near field data transmitter of said recording device and user terminal,
processing said primary transaction file on said user terminal for extracting at least a part of the transaction data, and generating an extract file,
inputting an authorization data set, in particular a PIN, of a debit or credit card configured as a smart card and equipped for wireless near field data transmission at said user terminal and associating said authorization data set with said extract file,
e1) transmitting said extract file and the associated authorization data set from said user terminal to the smart card wirelessly connected thereto, or
e2) internally transferring said extract file and the associated authorization data set to the smart card component in said user terminal,
f) checking said extract file in conjunction with said authorization data set by a processor of the smart card or smart card component based on comparison data stored thereon and, if correct, outputting a correctness confirmation message to said user terminal or internally in said user terminal,
g) generating a secondary transaction file comprising said primary transaction data and user data in said user terminal based on said confirmation message,
h) transmitting said secondary transaction file from said user terminal via said access network to an access server in said data network,
1) fetching or receiving a transaction confirmation message from said access server by or at a provider receiver and at least one of visually or acoustically displaying said message on said provider website.

2. A method for transmitting transaction data using a public data network, comprising the steps of:
b′) transmitting primary transaction data from a provider data base via said public data network to a user terminal of an access network connected to said data network and generating a primary transaction file in said user terminal,
processing said primary transaction file on said user terminal for extracting at least a part of the transaction data, and generating an extract file,
inputting an authorization data set of a debit or credit card configured as a smart card and equipped with a wireless near field data transmitter at said user terminal and associating said authorization data set with said extract file,
e1) transmitting said extract file and the associated authorization data set from said user terminal to the smart card wirelessly connected thereto, or
e2) internally transferring said extract file and the associated authorization data set to the smart card component in said user terminal,
checking said extract file in conjunction with said authorization data set by a processor of the smart card or smart card component based on comparison data stored thereon and, if correct, outputting a correctness confirmation message to said user terminal or internally in said user terminal,
generating a secondary transaction file comprising said primary transaction data and user data in said user terminal based on said confirmation message,
transmitting said secondary transaction file from said user terminal via said access network to an access server in said data network,
1) fetching or receiving a transaction confirmation message from said access server by or at a provider receiver and, in particular, visually and/or acoustically displaying said message on said provider website.

3. The method according to claim 1, wherein the following steps are carried out between steps h) and l):
forwarding said secondary transaction file from said access server to a transaction server or a server system on said data network,
generating a transaction confirmation message after processing said secondary transaction file for execution of the transaction on said transaction server or server system,
fetching said transaction confirmation message by provider software or actively sending said transaction confirmation message from said transaction server or server system to said provider receiver.

4. The method according to claim 1, further comprising the step of:
transmitting said transaction confirmation message via said access server and said access network to said user terminal of said access network and displaying it thereon.

5. The method according to claim 1, wherein said access network is a mobile communication network or WLAN and said user terminal is a smartphone or tablet on which a mobile app for executing steps c)-e2) and g) is installed and said mobile app checks said authorization data set in comparison with a secure element on a SIM card of said user terminal.

6. The method according to claim 1, wherein a proprietary input field is generated on a touch screen of said user terminal, and a position of said input field on said touch screen is specifically set for each input operation or for individual numeral inputs of an input operation.

7. The method according to claim 1, wherein the steps executed on said user terminal are executed within the scope of a secure execution environment, TEE, by a processor of said user terminal in a secure mode, wherein said mobile app authenticates itself to said processor of said user terminal, as a secure mobile app and wherein the switch to secure mode is effected by said mobile app.

8. The method according to claim 1, wherein said transaction data essentially comprises only one transaction number, and said user terminal, prior to generating said extract file in step c), obtains the remaining transaction data via the transaction server, assigned to said transaction number.

9. The method according to claim 5, wherein said mobile app demonstrates its authenticity to the user by the fact that the plug-in software module displays a warning message to said user that said transaction data has been acquired by an authentic mobile app if said plug-in software module has not received a confirmation message from said confirmation server in a certain time period after the presentation of said transaction data on said provider website.

10. The method according to claim 5, wherein said mobile app authenticates itself to said transaction server by at least one of a public key method or said mobile app and said transaction server communicate with one another in an encrypted manner.

11. The method according to claim 1, wherein step l), and optionally step k), are carried out at least partially via a confirmation functionality of said access server, irrespective of the current operating state of said user terminal.

12. The method according to claim 1, wherein the execution of steps f) and g) comprises the sub-steps of: first, checking the PIN on the smart card, and then generating a digital signature on the card based on said extract file by an asymmetric encryption method or generating a cryptogram by a symmetric encryption method and returning it as a correctness confirmation message to the smartphone, and then generating, by said smartphone, a secondary transaction file, which includes said correctness acknowledgment message and is forwarded to said access server for execution of the transaction.

13. The method according to claim 7, wherein an initial authenticity check of said trusted user interface is carried out, for which purpose a connection to an authentication web server is established and a mutual authentication of said mobile app and a web session implemented by said authentication web server is carried out.

14. An arrangement for transmitting transaction data using a public data network from a provider data base, in which primary transaction data is stored or generated, said arrangement comprising:
a display device connected to said public data network for at least one of visually or acoustically displaying said primary transaction data locally,
a user terminal connected to an access network of said public data network, comprising a data recorder that records said primary transaction data from said display device and a wireless near field data transmission,
a debit or credit card configured as a smart card comprising a wireless near field data transmitter and a processor for checking received data, which comprise an authorization data set of said smart card, based on comparison data stored on said smart card and, if correct, outputting a correctness confirmation message,
a mobile app installed on said user terminal for generating and processing a primary transaction file for extracting at least a part of said primary transaction data and generating an extract file as well as associating it with an authorization data set input at said user terminal; transmitting said extract file and the associated authorization data set from said user terminal to said smart card connected wirelessly thereto; generating a secondary transaction file comprising said primary transaction data and user data in said user terminal based on said correctness confirmation message, and transmitting said secondary transaction file from said user terminal via said access network to an access server in said data network,
an access server connected to said access network and said data network for receiving said secondary transaction file and generating and transmitting an authorization confirmation message at a provider receiver.

15. The arrangement according to claim 14, wherein said the near field data transmitter is configured according to a near field communication, NFC, protocol and the EMV standard for chip-based payment cards.

16. An arrangement for transmitting transaction data using a public data network from a provider data base in which primary transaction data is stored or generated, said arrangement comprising:
a display device connected to said public data network for at least one of visually or acoustically displaying said primary transaction data locally,
a user terminal connected to an access network of said public data network, comprising data recorder that records said primary transaction data from said display device and a wireless near field data transmitter,
a debit or credit card configured as a smart card component in said user terminal and comprising a processor for checking received data comprising an authorization data set of said debit or credit card based on comparison data stored in said smartcard component in said user terminal and, if correct, outputting a correctness confirmation message,
a mobile app installed on said user terminal for generating and processing a primary transaction file for extracting at least a part of said primary transaction data and generating an extract file as well as associating it with an authorization data set input at said user terminal, transferring said extract file and the associated authorization data set in said user terminal to the internal smart card, generating a secondary transaction file comprising said primary transaction data and user data in said user terminal based on said correctness confirmation message, and transmitting said secondary transaction file from said user terminal via said access network to an access server in said data network,
an access server connected to said access network and said data network for receiving said secondary transaction file and generating and transmitting an authorization confirmation message to a provider receiver.

17. An arrangement for transmitting transaction data using a public data network from a provider data base in which primary transaction data is stored or generated, said arrangement comprising:
a user terminal connected to an access network of said public data network, comprising a receiver that receives said primary transaction data via said data network,
a debit or credit card configured as a smart card component in said user terminal and comprising a processor for checking received data comprising an authorization data set of said debit or credit card based on comparison data stored in said smartcard component in said user terminal and, if correct, outputting a correctness confirmation message,
a mobile app installed on said user terminal for generating and processing a primary transaction file for extracting at least a part of said primary transaction data and generating an extract file as well as associating it with an authorization data set input at said user terminal, transferring said extract file and the associated authorization data set in said user terminal to said internal smart card, generating a secondary transaction file comprising said primary transaction data and user data in said user terminal based on said correctness confirmation message, and transmitting said secondary transaction file from said user terminal via said access network to an access server in said data network,
an access server connected to said access network and said data network for receiving said secondary transaction file and generating and transmitting an authorization confirmation message to a provider receiver.

18. The arrangement according to claim 17, wherein a secure element for storing said comparison data for said authorization data set is provided on a SIM card of said user terminal.

19. The arrangement according to claim 17, wherein said access server is configured to transmit said authorization confirmation message via said access network to said user terminal.

20. The arrangement according to claim 17, wherein said access server is configured to forward said secondary transaction file to said data network, and a transaction server or a server system is provided in said data network for processing said secondary transaction file for execution of the transaction and generating a transaction confirmation message.

21. The arrangement according to claim 17, wherein said access network is a mobile communications network or WLAN and said user terminal is a smartphone or tablet on which said mobile app is installed, and said mobile app provides a proprietary input field on the touch screen of said user terminal for inputting the PIN of said debit or credit card, wherein a position of said input field on said touch screen is specifically set for each input operation or for individual numeral inputs of an input operation.

22. The arrangement according to claim 17, wherein said access network is a mobile communications network or WLAN and said user terminal is a smartphone or tablet on which said mobile app is installed, and said user terminal including said mobile app is configured for in a Trusted Execution Environment, TEE, and said mobile app is configured for securely controlling hardware components of said user terminal.

23. The arrangement according to claim 17, wherein said user terminal has a device key for authentication at least with respect to an app loading system, comprising a private key in terms of a public key infrastructure, PKI.

24. The arrangement according to claim 21, wherein said mobile app is configured to control that first said PIN is checked on said smart card, and then said extract file is digitally signed by a private key on said smart card and returned to the smartphone as a correctness confirmation message, and then said smartphone generates a secondary transaction file, which includes said correctness confirmation message and is forwarded to said access server for execution of the transaction.

25. The arrangement according to claim 22, wherein said arrangement comprises an authentication web server with which an initial authenticity check of said trusted user interface is carried out, for which purpose a connection with said authentication web server is established and a mutual authentication of said mobile app and a web session implemented by said authentication web server is carried out.
